(19) United States
(12) Patent Application Publication
(10) Pub. No.: US 2006/0172838 A1
(43) Pub. Date: Aug. 3, 2006

(54) Motorcycle drive system cover assembly

(76) Inventor: Christopher C. DaSantos, Elk, WA (US)

Correspondence Address: PERKINS, SMITH & COHEN LLP, ONE BEACON STREET, 30TH FLOOR, BOSTON, MA, 02108, US

(21) Appl. No.: 11/046,035

(22) Filed: Jan. 28, 2005

(51) Int. Cl. B62J 13/00; F16H 57/02

(52) U.S. Cl. 474/144

(57) ABSTRACT

Apparatus for substantially covering a motorcycle open belt primary drive system that improves the safety of the motorcycle riders as well as protects the drive system of the motorcycle. The apparatus is capable of being mounted to a conventional drive system and frame of a motorcycle having an open belt primary drive system. The apparatus includes a front pulley cover assembly, a rear pulley cover assembly, and a grill. Each pulley cover assembly includes a bearing housing that is attached to the drive system pulley of a motorcycle, a pulley cover, and a bearing that joins the bearing housing and the pulley cover into a single assembly. The bearing provides a reduced friction connection between the bearing housing and the pulley cover that allows the pulley cover to freely rotate or spin independent of the bearing housing.

### FIELD OF THE INVENTION

The present invention relates to one or more covers for a motorcycle open belt primary drive. Specifically, the invention relates to a protective housing that can be removably attached to the motorcycle and includes at least one free-spinning pulley cover.

### BACKGROUND OF THE INVENTION

A motorcycle generally includes an engine, steering assembly, front and rear wheels, a transmission operably connected to the rear wheel, a drive system for transmitting power from the engine to the transmission, which is generally located directly behind the engine, and a frame. The drive system generally includes a pulley system called a primary drive. The engine transmits power or energy from the crankshaft to the clutch housing of the transmission through the primary drive, which is illustrated as a belt drive herein but is adaptable to a chain drive. Then the energy is transferred from the transmission to the rear wheel through a final drive, which can be a belt or chain, to propel the motorcycle.

Due to the design of a motorcycle, the rotating or moving drive system is generally exposed, which can lead to dangerous conditions for the motorcyclist, as well as the motorcycle. A common problem among motorcyclists is getting shoelaces, baggy pants such as bellbottoms, or other loose materials caught in the drive system of a motorcycle while it is running, which can cause accidents, injuries, and death. Also, debris and other foreign matter from the road can also damage the drive system if the drive system is exposed to the outside environment.

U.S. Patent Application Publication 2004/0118240 A1 (Young) discloses an adaptive drive system cover for motorcycles that encloses the entire chain or belt. This cover is unitary and heavy, and has no means for rotational movement.

WO 2004/024468 A2 (Rivers et al.) discloses a free spinning rim for the wheels of a motorcycle. This rim provides ornamental appeal by revolving about the axle shaft at a different speed than the wheel, but does not provide the motorcyclist with any safety features.

U.S. Design patents D273,947 (Johnson) and D294,131 (Stahel) disclose ornamental open motorcycle primary cover, but do not disclose any rotating elements.

U.S. Patent Application Publication 2004/0259673 A1 (Bertrand et al) discloses pulley cover for snowmobiles that encloses the entire chain or belt. This cover is unitary and heavy, and has no means for rotational movement.

It is therefore a need for a pulley cover that is lightweight and rotates to provide a safety function as well as an ornamental design.

### BRIEF SUMMARY OF THE INVENTION

The needs for the invention set forth above as well as further and other needs and advantages of the present invention are achieved by the embodiments of the invention described herein below.

The present invention substantially covers a motorcycle open belt primary drive system to improve the safety of the motorcycle riders as well as protects the drive system of the motorcycle while not adding a significant amount of weight. The present invention is capable of being mounted to a conventional drive system and conventional belt tensioner plates having an open belt primary drive system. The present invention includes a front pulley cover assembly, a rear pulley cover assembly, and a grill. Each pulley cover assembly includes a bearing housing that is attached to the drive system pulley of a motorcycle, a pulley cover, and a bearing that joins the bearing housing and the pulley cover into a single assembly. The bearing provides a reduced friction connection between the bearing housing and the pulley cover that allows the pulley cover to freely rotate or spin independent of the bearing housing.

In one embodiment of the present invention, a front pulley cover and a rear cover display a rotating ornamental design.

In another embodiment of the present invention, the space between the front pulley cover and the rear cover houses a decorative grill.

It is the object of the present invention to provide a pulley cover that protects the motorcyclist and prevents the clothing and apparel of the motorcyclist from coming in contact with the edges of an open primary drive belt and the exposed features of the pulley, such as edges, outer flange, bore cavity, and clutch plate and screws.

It is another object of the present invention to provide a lightweight pulley cover assembly that is adaptable to an existing drive system of a motorcycle.

### BRIEF DESCRIPTION OF THE DRAWINGS

FIG. 1 is a perspective side view of an exemplary embodiment of the present invention attached to a motorcycle;

FIG. 2 is a front view of the present invention of FIG. 1;

FIG. 3 is a pictorial view of the present invention of FIG. 1;

FIG. 4 is a pictorial view of a front pulley wheel of a motorcycle with the present invention removed;

FIG. 5 is a pictorial view of a rear pulley wheel and clutch of a motorcycle with the present invention removed;

FIG. 6A is an exploded view of an exemplary embodiment of a front pulley cover assembly of the present invention of FIG. 1;

FIGS. 6B and 6C illustrate an alternative embodiment of the present invention for joining the front pulley cover and the front cylindrical bearing support;

FIG. 7A is an exploded view of an exemplary embodiment of a rear pulley cover assembly of the present invention of FIG. 1;

FIGS. 7B and 7C illustrate an alternative embodiment of the present invention for joining the rear pulley cover and the rear cylindrical bearing support;

FIG. 8 is a front view of a grill of present invention of FIG. 1; and

FIG. 9 is a top view of a grill mount of the present invention of FIG. 1.

### DETAILED DESCRIPTION OF PREFERRED EMBODIMENTS

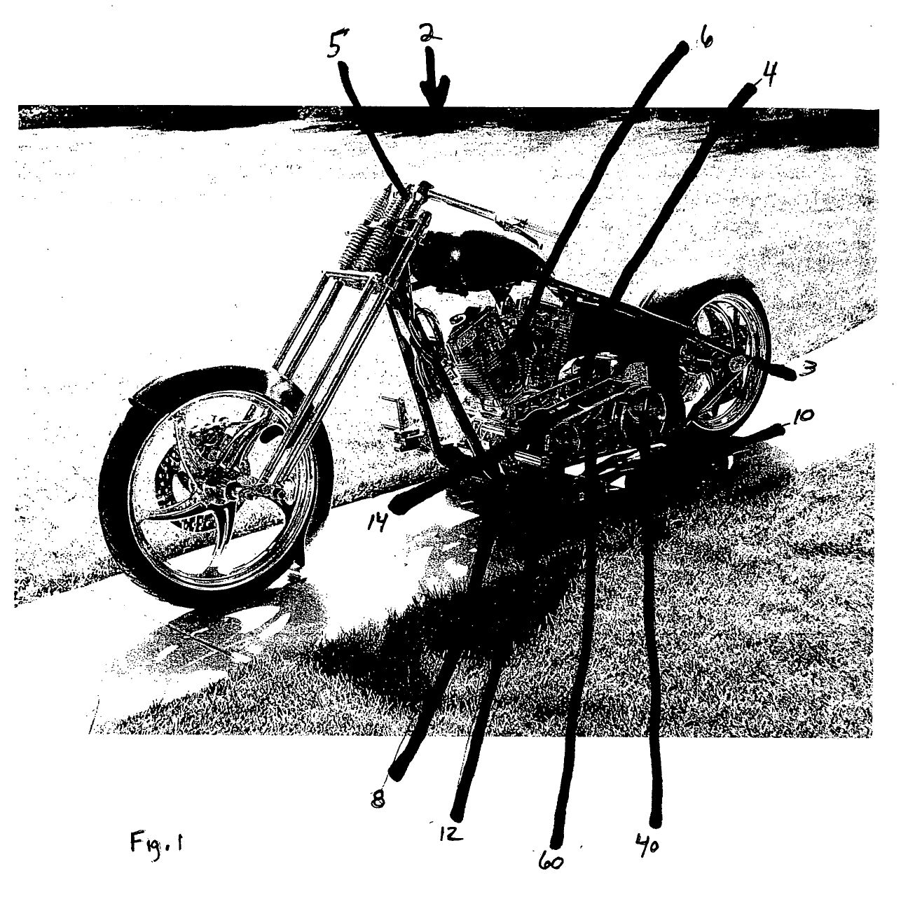

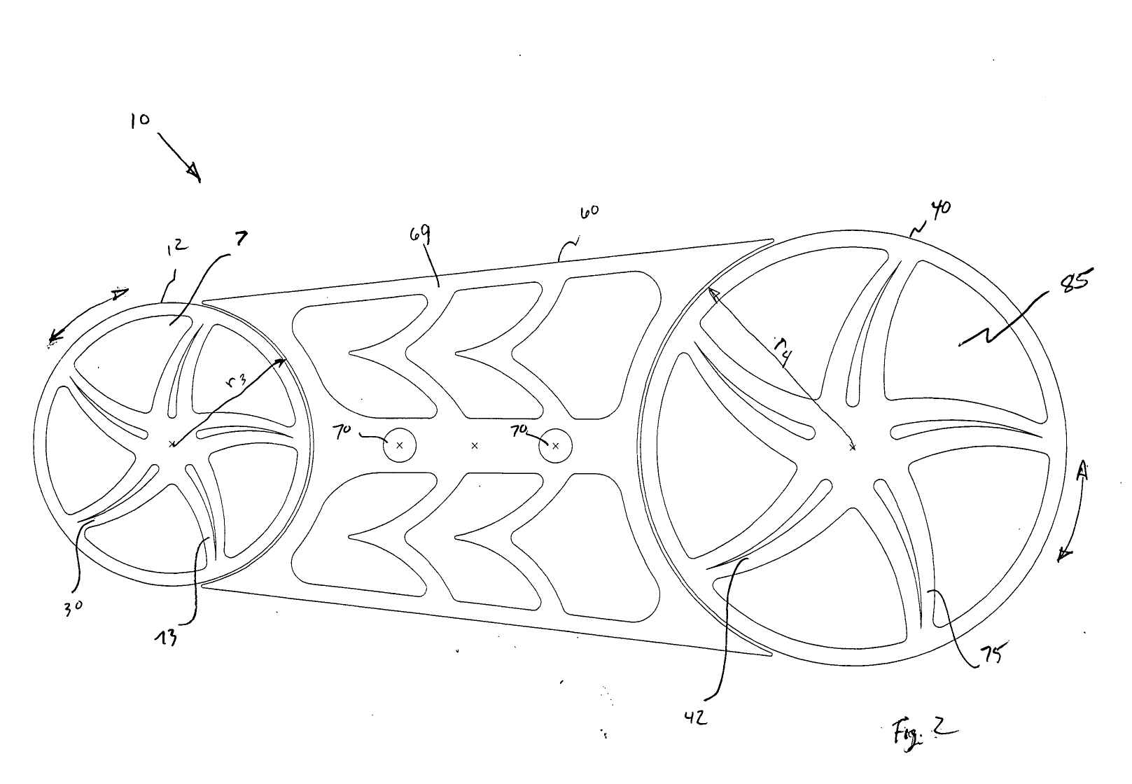

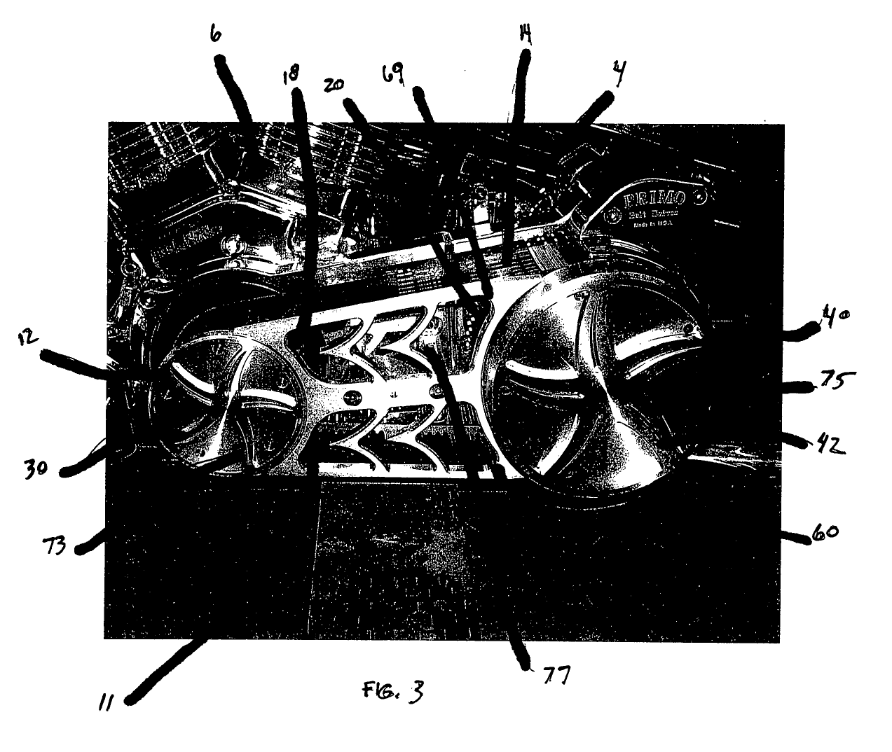

The present invention substantially covers, for example, a conventional open belt primary drive of a motorcycle as shown in FIG. 1 and is designated generally therein by the reference character 10. FIG. 1 illustrates the present invention 10 adapted to a motorcycle 2. The motorcycle 2 includes a steering assembly 5, a drive system having transmission 4 and engine 6 interconnected by primary belt 14, and all being connected or otherwise attached to frame 8 of motorcycle 2. Furthermore, FIG. 2 shows an a pictorial front view of an exemplary embodiment of the present invention 10 including front pulley cover 12, rear pulley cover 40, and grill 60 oriented between covers 12 and 40, whereby present invention 10 covers the entire length of primary belt 14 and belt cavity 11 formed therein (FIG. 3). Returning to FIG. 2, the two-way arrows indicate that covers 12, 40 are capable of rotation in either the clockwise or counter-clockwise direction depending on the forces exerted on covers 12, 40. Grill 60 is generally a static component.

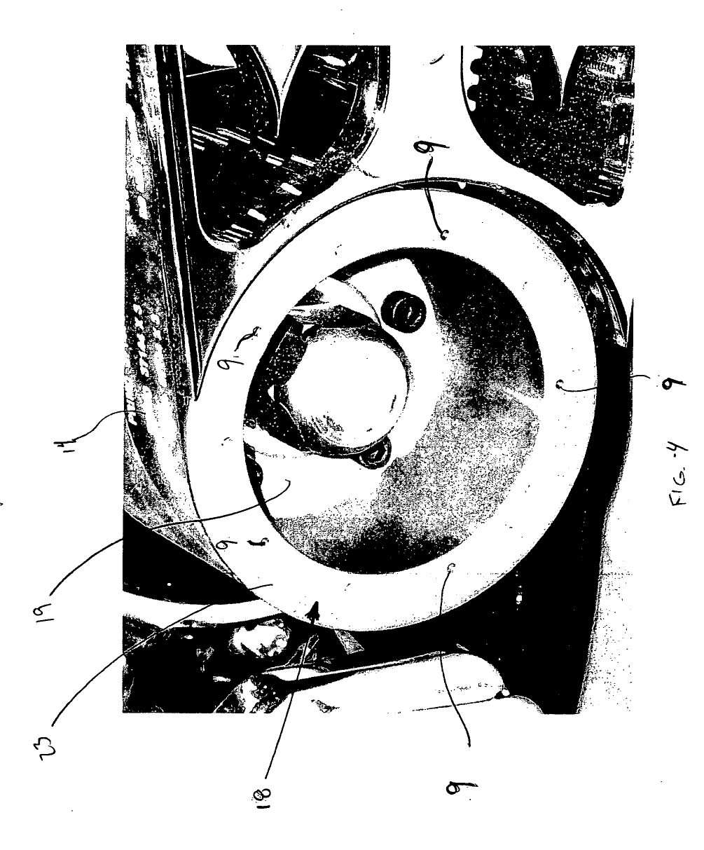

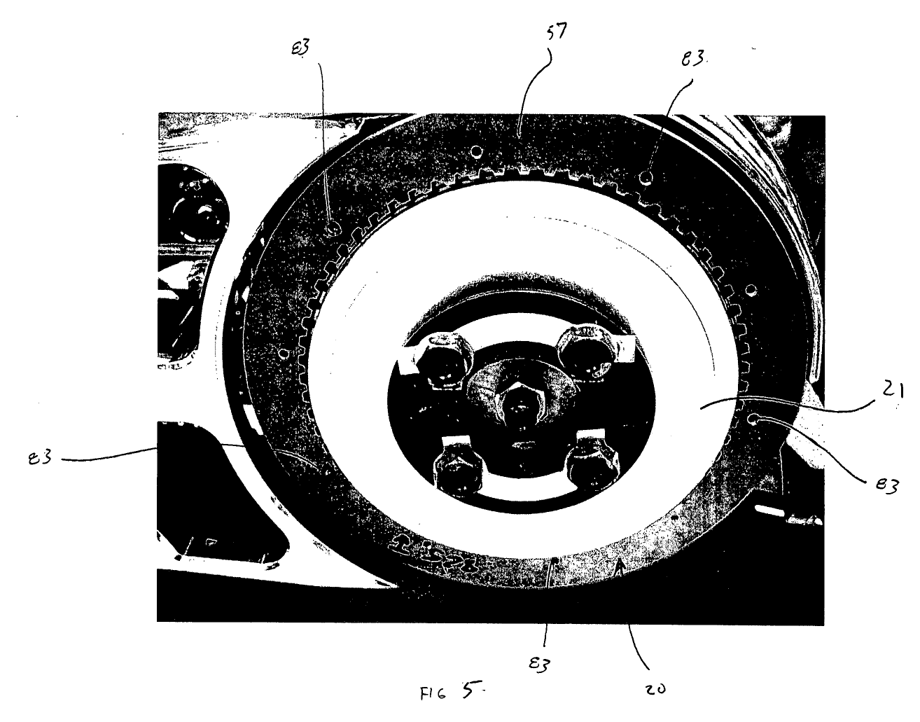

Now referring to FIGS. 3, 4, and 5, during the operation of motorcycle 2 (FIG. 1), engine 6 transmits torque or power through a crankshaft (not shown) that is transformed into a rotation velocity causing the crankshaft to rotate at a predetermined rotational speed. Front pulley wheel 18 (FIGS. 3 and 4) is conventionally attached (e.g., bolted) to the crankshaft (not shown) at inner flange 19, which results in front pulley wheel 18 rotating while the crankshaft is rotating. Primary belt 14 is mounted on front pulley wheel 18 and rear pulley wheel 20, and transfers the engine power or energy from front pulley wheel 18 to rear pulley wheel 20 causing rear pulley wheel 20 to rotate. Rear pulley wheel 20 in turn is connected to rear clutch basket 21 (FIG. 5), which is operably connected to transmission 4 and drives rear wheel 3 of the motorcycle 2 (FIG. 1).

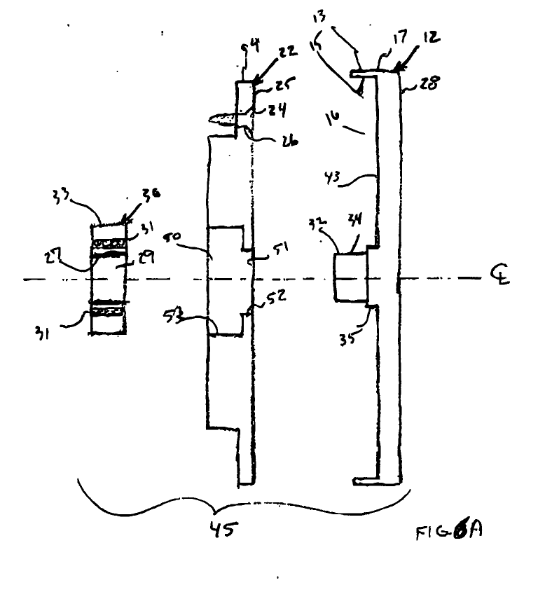

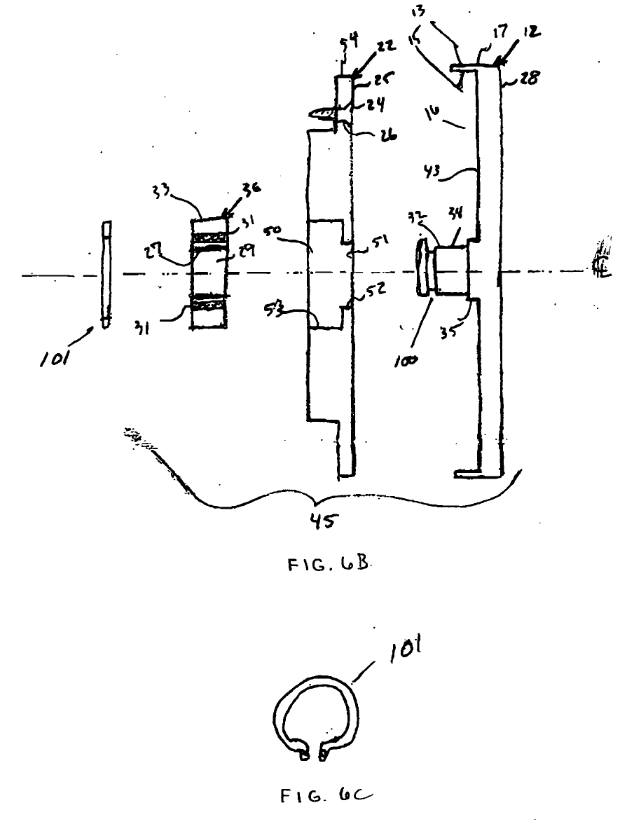

FIG. 6A illustrates an exploded side view of front pulley cover assembly 45, which is generally identical to the rear pulley cover assembly 55 (described in detail below). Front pulley cover assembly 45 includes front bearing support 36, front bearing housing (also referred to as front mounting plate) 22, and front pulley cover 12. Front pulley cover 12 includes front face 28 with an ornamental design 30 (FIGS. 2 and 3) and cylindrical shaft 32 extending orthogonally outward from rear face 43. Cylindrical shaft 32 includes first outer circumferential surface 34 and second outer circumferential surface 35. Front bearing housing 22 includes inner cylindrical bearing bore 50 and outer cylindrical bearing bore 51, which form first inner circumferential surface 53 and second inner circumferential surface 52, respectively. Inner cylindrical bearing bore 50 and outer cylindrical bearing bore 51 are sized larger than the outer surface thickness or radial dimensions of outer circumferential surface 34 and second outer circumferential surface 35 such that cylindrical shaft 32 can be freely received therein without interference (discussed below in detail) into inner cylindrical bearing bore 50 and outer cylindrical bearing bore 51.

Front cylindrical bearing support 36 is joined to front bearing housing 22 and front pulley cover 12 by conventional joining means such as, for example, bolts/screws, adhesive, welding, brazing, complimentary threaded male/female members, and friction, press-fit or interference fit. For illustration purposes only, the friction, press-fit, or interference fit joining means will be disclosed, but such disclosure is not meant to limit the present invention to only the disclosed embodiment. Front cylindrical bearing support 36 includes cylindrical bearing bore 29 that forms inner circumferential surface 27. Inner circumferential surface 27 has a slightly smaller diameter than the diameter or radial thickness of outer circumferential surface 34 of cylindrical shaft 32. The difference in the diameter or radial dimensions is the interference fit dimension. To join front cylindrical bearing support 36 to front pulley cover 12, the components must be press-fit together to overcome the frictional and the normal forces applied to the mating contact surfaces 27, 34 caused by larger diameter or radial thickness of cylindrical shaft 32 being inserted into the smaller diameter cylindrical bearing bore 29 of front cylindrical bearing support 36. After the press-fit operation, front pulley cover 12 is connected to front cylindrical bearing support 36 by an interference fit that is sufficient to retain frictional load under normal operating conditions.

Front cylindrical bearing support 36 is also connected to front bearing housing 22, for example, by an interference fit sufficient to retain frictional load under normal operating conditions. Outer circumferential surface 33 of front cylindrical bearing support 36 has a slightly larger diameter or radial thickness than the diameter of first inner circumferential surface 53 of front bearing housing 22. As described above, the difference in the diameter or radial dimensions is the interference fit dimension. To join front cylindrical bearing support 36 to front bearing housing 22, the components must be press-fit together to overcome the frictional and the normal forces applied to the mating contact surfaces 33, 53 caused when the larger diameter or radial thickness of bearing support 36 is inserted into the smaller diameter of inner cylindrical bearing bore 50 of front bearing housing 22. After the press-fit operation, front bearing housing 22 is connected to front cylindrical bearing support 36 by an interference fit that is sufficient to retain frictional load under normal operating conditions.

Front bearing housing 22 mounts to outer flange 23 (FIG. 4) of front pulley wheel 18. Front bearing housing 22 includes countersunk screw holes 26 spaced substantially equidistant along the outer radial circumference 25 of front bearing housing 22. Front pulley wheel 18 includes complimentary screw holes 9 that match the circular pattern of countersunk screw holes 26. Screw holes 9 can be drilled/tapped into front pulley wheel 18 at the time of installation if not already available on conventional off-the-shelve front pulley wheels. A plurality of conventional screws 24 (FIG. 6A) threaded through countersunk screw holes 26 and screw holes 9 clamp front bearing housing 22 (and front pulley cover assembly 45) to front pulley wheel 18. Countersunk screw holes 26 are accessible through opening in front face 28 of front pulley cover 12, for example apertures 7 formed by ornamental design 30 of front pulley cover 12.

Ball bearings 31 (FIG. 6A) allow front pulley cover 12 to rotate freely and independently of front bearing housing 22, front pulley wheel 18, and primary belt 14.

In operation, front pulley cover 12 begins to rotate initially at substantially the same rotational speed as front pulley wheel 18 until frictional bearing loads are overcome. Front pulley cover 12 rotational speed is also a function of aerodynamic loads applied when the motorcycle 2 is in motion. The motorcycle may create airflow over the outer surfaces of the present invention as the motorcycle is moving. The airflow over front face 28 of front pulley cover 12 can created aerodynamic forces on the protrusions 73 of the ornamental design 30 (FIGS. 2 and 3), which act like sails of the sailboat, that will cause front pulley cover 12 to rotate. Also, airflow over front face 28 can create a pressure differential along front face 28 that will also naturally cause front pulley cover 12 to rotate or spin even if there are no protrusions on front face 28. When motorcycle 2 is at rest and engine 6 is turned off, front pulley cover 12 will continue to rotate or spin naturally until frictional bearing loads or bearing drag cause front pulley cover 12 to stop.

Further, while motorcycle 2 is in motion or at rest and engine 6 is on or pulleys wheels 18, 20 or belt 14 are otherwise moving, any obstacle (for example, clothing, hands, feet, arms, legs, road debris, etc.) that comes in contact with front pulley cover 12 or rear pulley cover 40 will cause front pulley cover 12 or rear pulley cover 40 to immediately reduce rotation speed relative to the drive system and stop rotation when necessary to avoid further progress of the obstacle into the drive system, and further prevent damage or ham to the obstacle, in particular, the riders.

Now returning to FIG. 6A, front pulley cover 12 can include rim 13 extending horizontally outward towards front bearing housing 22 and substantially in parallel to cylindrical shaft 32. Inner circumferential surface 15 of rim 13 has a radial dimension from the centerline of front pulley assembly 45 greater than the radial dimension of outer surface 54 of front bearing housing 22 such that front bearing housing 22 is freely received therein without interference into cavity 16 of front pulley cover 12 when the components of front pulley cover assembly 45 are joined together (described above). The longitudinal length of rim 13 or depth of cavity 16 is sufficient such that outer surface 54 of front bearing housing 22 is substantially encased or isolated by front pulley cover 12, but the longitudinal length of rim 13 is not long enough to interfere with the operation of belt 14 when attached to front pulley wheel 18. Thereby, any obstacle that extends beyond front face 28 of front pulley cover 12 towards the drive system will not be drawn into the drive system by the rotational and aerodynamic effects of front bearing housing 22 and belt 14.

Further, rim outer surface 17 of rim 13 can be extended to a radial dimension from the centerline of front pulley cover assembly 45 greater than the radial dimension of belt 14 (FIGS. 3 and 4), thereby further preventing an obstacle from being drawn into the drive system due to aerodynamics or drafting effects of belt 14.

FIGS. 6B and 6C illustrate an alternative embodiment of the present invention that includes a snap ring groove 102 formed in shaft 32 of front pulley cover 12 and snap ring 101. In addition to or in place of the interference fit disclosed above to join front pulley cover 12 and front cylindrical bearing support 36, snap ring 101 is inserted into cooperating snap ring groove 102 once the components of front pulley cover assembly 45 have been fully assembled. The reference numbers of the other features of front pulley cover 12, front cylindrical bearing support 36, and front bearing housing 22 remain the same as disclosed in FIG. 6A.

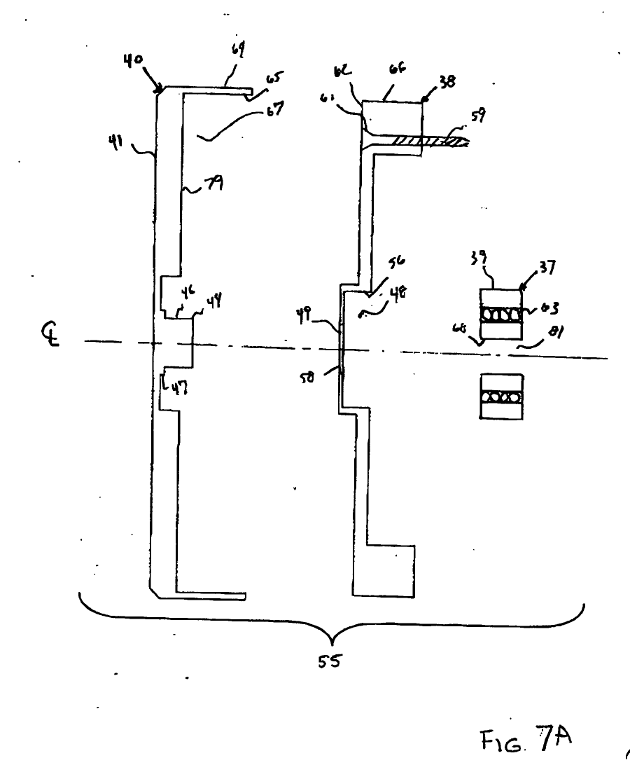

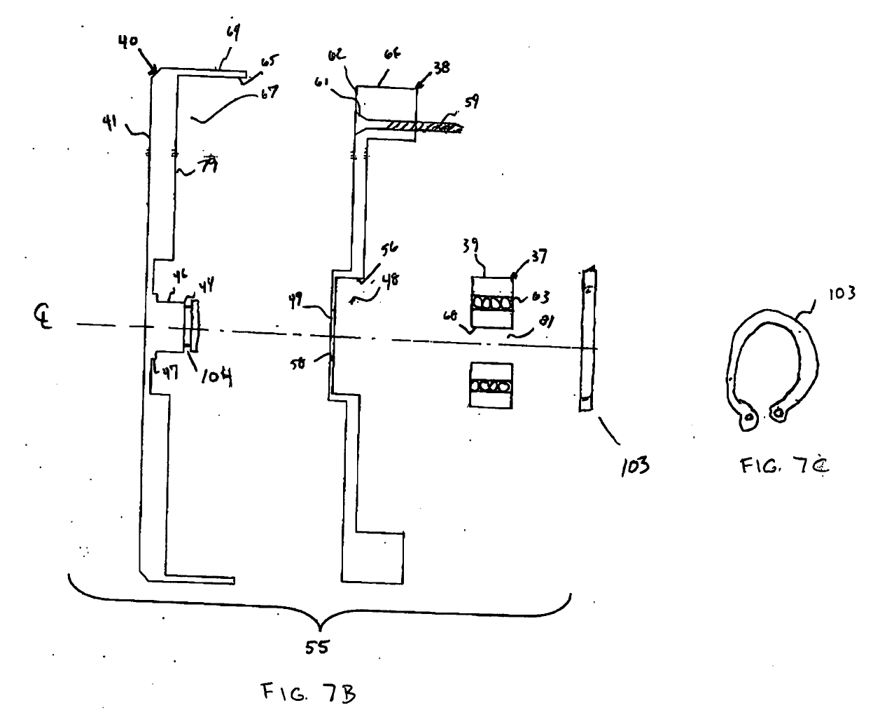

FIG. 7A illustrates an exploded side view of rear pulley cover assembly 55, which is generally identical to the front pulley cover assembly 45. Rear pulley cover assembly 55 includes rear bearing support 37, rear bearing housing (also referred to as rear mounting plate) 38, and rear pulley cover 40. Rear pulley cover 40 includes front face 41 with an ornamental design 42 (FIGS. 2 and 3) and cylindrical shaft 44 extending orthogonally outward from rear face 79. Cylindrical shaft 44 having first outer circumferential surface 46 and second outer circumferential surface 47. Rear bearing housing 38 includes inner cylindrical bearing bore 48 and outer cylindrical bearing bore 49, which form first inner circumferential surface 56 and second inner circumferential surface 58, respectively. Inner cylindrical bearing bore 48 and outer cylindrical bearing bore 49 are sized larger than the outer surface thickness or radial dimensions of first outer circumferential surface 46 and second outer circumferential surface 47 such that cylindrical shaft 44 can be freely received therein without interference (as discussed above and further discussed below in detail) into inner cylindrical bearing bore 48 and outer cylindrical bearing bore 49.

Rear cylindrical bearing support 37 is joined to rear bearing housing 38 and rear pulley cover 40 by conventional joining means such as, for example, bolts/screws, adhesive, welding, brazing, complimentary threaded male/female members, and friction, press-fit or interference fit. For illustration purposes only, the friction, press-fit, or interference fit joining means will be disclosed, but such disclosure is not meant to limit the present invention to only the disclosed embodiment. Rear cylindrical bearing support 37 includes cylindrical bearing bore 81 that forms inner circumferential surface 68. Inner circumferential surface 68 has a slightly smaller diameter than the diameter or radial thickness of outer circumferential surface 46 of cylindrical shaft 44. The difference in the diameter or radial dimensions is the interference fit dimension. To join rear cylindrical bearing support 37 to rear pulley cover 40, the components must be press-fit together to overcome the frictional and the normal forces applied to the mating contact surfaces 46, 68 caused by larger diameter or radial thickness of cylindrical shaft 44 being inserted into the smaller diameter cylindrical bearing bore 81 of rear cylindrical bearing support 37. After the press-fit operation, rear pulley cover 40 is connected to rear cylindrical bearing support 37 by an interference fit that is sufficient to retain frictional load under normal operating conditions.

Rear cylindrical bearing support 37 is also connected to rear bearing housing 38, for example, by an interference fit sufficient to retain frictional load under normal operating conditions. Outer circumferential surface 39 of rear cylindrical bearing support 37 has a slightly larger diameter or radial thickness than the diameter of first inner circumferential surface 56 of rear bearing housing 38. As described above, the difference in the diameter or radial dimensions is the interference fit dimension. To join rear cylindrical bearing support 37 to rear bearing housing 38, the components must be press-fit together to overcome the frictional and the normal forces applied to the mating contact surfaces 39, 56 caused when the larger diameter or radial thickness of rear cylindrical bearing support 37 being inserted into the smaller diameter inner cylindrical bearing bore 48 of rear bearing housing 38. After the press-fit operation, rear bearing housing 38 is connected to rear cylindrical bearing support 37 by an interference fit that is sufficient to retain frictional load under normal operating conditions.

Rear bearing housing 38 mounts to outer flange 57 (FIG. 5) of rear pulley wheel 20. Rear bearing housing 38 includes countersunk screw holes 61 (FIG. 7A) spaced substantially equidistant along the outer radial circumference 62 of rear bearing housing 38. Rear pulley wheel 20 includes complimentary screw holes 83 (FIG. 5) that match the circular pattern of countersunk screw holes 61. Screw holes 83 can be drilled/tapped into rear pulley wheel 20 at the time of installation if not already available on conventional off-the-shelve rear pulley wheels. A plurality of conventional screws 59 (FIG. 7A) threaded through countersunk screw holes 61 and screw holes 83 clamp rear bearing housing 38 (and rear pulley cover assembly 55) to rear pulley wheel 20. Countersunk screw holes 61 are accessible through opening in front face 41 of rear pulley cover 40, for example apertures 85 (FIG. 2) formed by ornamental design 42 of rear pulley cover 40.

Ball bearings 63 (FIG. 7A) allow rear pulley cover 40 to rotate freely and independently of rear bearing housing 38, rear pulley wheel 20, and primary belt 14.

FIGS. 7B and 7C illustrate an alternative embodiment of the present invention that includes a snap ring groove 104 formed in shaft 44 of rear pulley cover 40 and snap ring 103. In addition to or in place of the interference fit disclosed above to join rear pulley cover 40 and rear cylindrical bearing support 37, snap ring 103 is inserted into cooperating snap ring groove 104 once the components of rear pulley cover assembly 55 have been fully assembled. The reference numbers of the other features of rear pulley cover 40, rear cylindrical bearing support 37, and rear bearing housing 38 remain the same as disclosed in FIG. 7A.

In operation, rear pulley cover 40 begins to substantially rotate initially at the same rotational speed as rear pulley wheel 20 until frictional bearing loads are overcome. Rear pulley cover 40 rotational speed is also a function of aerodynamic loads applied when the motorcycle 2 is in motion. The motorcycle may create airflow over the outer surfaces of the present invention as the motorcycle is moving. The airflow over front face 41 of rear pulley cover 40 can created aerodynamic forces on the protrusions 75 (FIGS. 2 and 3) of the ornamental design 42, which act like sails of the sailboat, that will cause rear pulley cover 40 to rotate. Also, airflow over front face 41 can naturally create a pressure differential along front face 41 that will also cause rear pulley cover 40 to rotate or spin even if there are no protrusions on face 41. When motorcycle 2 is at rest and engine 6 is turned off, rear pulley cover 40 will continue to rotate or spin naturally until frictional bearing loads or bearing drag cause rear pulley cover 40 to stop.

Further, while motorcycle 2 is in motion or at rest and engine 6 is on or pulley wheels 18, 20 or belt 14 are otherwise moving, any obstacle (for example, clothing, hands, feet, limbs, road debris, etc.) that comes in contact with front pulley cover 12 or rear pulley cover 40 will cause front pulley cover 12 or rear pulley cover 40 to immediately reduce rotation speed relative to the drive system and stop rotation when necessary to avoid further progress of the obstacle into the drive system, and further prevent damage or harm to the obstacle, in particular, the riders.

Now returning to FIG. 7A, rear pulley cover 40 can include rim 64 extending horizontally outward towards rear bearing housing 38 and substantially parallel to cylindrical shaft 44. Inner circumferential surface 65 of rim 64 has a radial dimension from the centerline of rear pulley assembly 55 greater than the radial dimension of outer surface 66 of rear bearing housing 38 such that rear bearing housing 38 is freely received therein without interference into cavity 67 of rear pulley cover 40 when the components of rear pulley cover assembly 55 are joined together (described above). The longitudinal length of rim 64 or depth of cavity 67 is sufficient such that outer surface 66 of rear bearing housing 38 is substantially encased or isolated by rear pulley cover 40, but the longitudinal length of rim 64 is not long enough to interfere with the operation of belt 14 when rear bearing housing 38 (and rear pulley cover assembly 55) is attached to rear pulley wheel 20. Thereby, any obstacle that extends beyond front face 41 of rear pulley cover 40 towards the drive system will not be drawn into the drive system by the rotational and aerodynamic effects of rear bearing housing 38 and belt 14.

Further, rim outer surface 65 of rim 64 can be extended to a radial dimension from the centerline of rear pulley cover assembly 55 greater than the radial dimension of belt 14, thereby further preventing an obstacle from being drawn into the drive system due to aerodynamics or drafting effects of belt 14.

Now returning to FIGS. 6A and 7A, outer diameters of rim 17, 64 of front pulley cover 12 and rear pulley cover 40, respectively, are larger than front pulley wheel 18 and rear pulley wheel 20, respectively (as described above). In an exemplary embodiment, the outer diameter of front cover 12 is approximately ⅓ smaller than the outer diameter of rear pulley cover 40 based on the characteristics of the motorcycle drive system, particularly pulley wheels 18, 20, as illustrated herein. Actual dimensions of pulley covers, bearings, and bearing housings are dependent on the particular make and model of the motorcycle and are not to be limited to the illustrations contained herein.

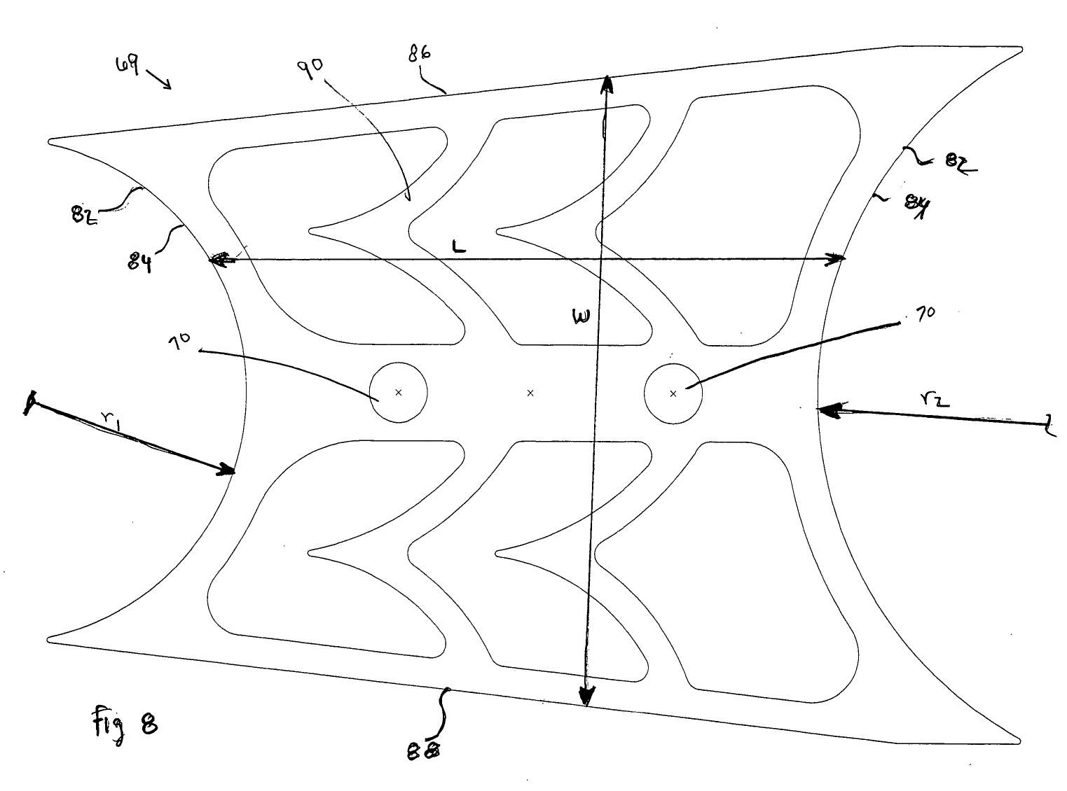

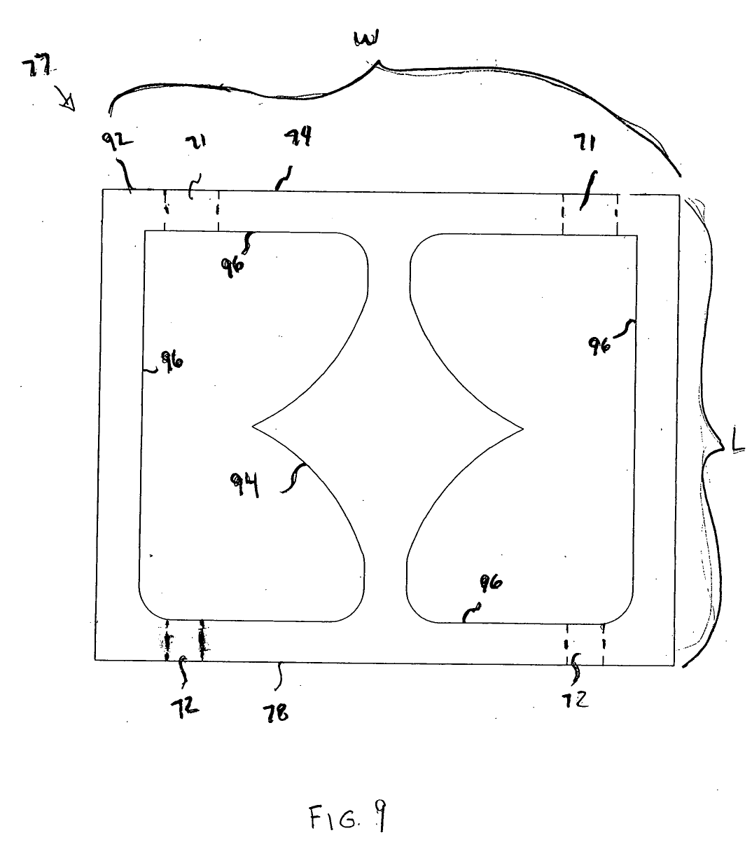

Referring to FIGS. 8 and 9, an alternative embodiment of the present embodiment includes grill 60 that completes the ornamental design and protects the entire drive system from any obstacles contacting or interfering with belt 14, front pulley wheel 18, and rear pulley wheel 20. Grill 60 is located between front cover 12 and rear cover 40 as shown in FIGS. 1-3 and attached to frame 8 of motorcycle 2.

Grill 60 can include a front plate 69 and a longitudinal structural member or grill mount 77 orthogonally attached to the rear side (not shown) of front plate 69 forming a generally T-shaped configuration. Front plate 69 and grill mount 77 can be a unitary component or multiple of attachably removable separate components. The unitary component is formed by front plate 69 and grill mount 77 being permanently connected by conventional attachment means including, but not limited, to welding, brazing, adhering, or other joining processes. The following description of grill 69 and grill mount 77 illustrate a two component configuration, but it is not intended to limit the present invention to only the disclosed configuration. Further, there could be more than two components depending on the mounting requirements to the frame 8 of a particular motorcycle 2.

Front plate 69 is generally trapezoidal in shape and of sufficient length L to span the distance between pulley covers 12, 40 and of sufficient width w to cover belt cavity 11. Front plate 69 can include sides 82 having semi-circular cutouts 84. Cutouts 84 have slightly larger radii r1, r2 than radii r3, r4, respectively, of the adjacent pulley covers 12, 40 (FIG. 2). Upper side 86 and lower side 88 are tapered outward from front pulley cover 12 to rear pulley cover 40 to create a smooth transient between front plate 69 and pulley covers 12, 40, thereby minimizing open spaces between the assembled components in the present invention for obstacles, debris and/or other foreign matter to enter the drive system. In an exemplary embodiment, the tampered sides are substantially tangent to the outer diameter circumference of the pulley covers 12, 40. Front plate 69 can include outer grill holes 70 for mounting front plate 69 with conventional bolts or screws to outer grill mount holes 72 in outer face 78 of grill mount 77 (FIG. 9 and discussed in detail below). Front plate 69 can also include an ornamental design 90.

Grill mount 77 can be a longitudinal structural member being generally a rectangular frame 92 of length L longer than the width of belt 14 and, particularly, being of sufficient length to connect front plate 69 to frame 8 of motorcycle 2 without interference with the operation of belt 14. Inner face 74 of grill mount 77 includes inner grill holes 71 for mounting with conventional bolts or screws to belt tensioner plates (not shown) of motorcycle 2 having complimentary holes (not shown). The belt tensioner plates are adjustably attached to engine 6 and transmission 4. The width w of grill mount 77 is of sufficient length to accommodate the bolt pattern of inner grill mount holes 71 and outer grill mount holes 72. The thickness (FIG. 9 in plane) of grill mount 77 is dependent on the size of grill mount holes 71, 72. The thickness of grill mount 77 must further be sufficient to structurally support front plate 69. Grill mount 77 may further include one or more support members 94 interconnecting sides 96 of frame 92 for additional structural support. One or more support members 94 can interconnect sides 96 in any arrangement suitable to meet the structural requirements of grill 60 and is not to be limited to illustrations contained herein.

Any metal, polymer, or composite materials that are capably of withstanding the operating and environment conditions experienced by motorcycle 2 are suitable for the components of the present invention. For example, billet 6061 aluminum, a typical alloy used in aircrafts, can be used for front pulley cover 12 and rear pulley cover 40.

As described above, the front bearing housing 22 and rear bearing housing 38 initially rotate at a speed consistent with that of pulley wheels 18, 20. Front and rear pulley covers 12, 40 are however free-spinning and thus will stop spinning if there is adequate resistance, a safety feature to prevent clothes or other materials from getting caught in the other pulley covers, or exposed pulley wheels or belt. Once the front and rear pulley covers 12, 40 are put into motion by the rotation of the front and rear bearing housings 22, 38, covers 12, 40 will continue to spin, driven by the pressure differential and the force of the wind on the exterior surfaces of the pulley covers when the motorcycle is in motion or moving.

The ornamental designs shown herein are for illustrations purposes only and not intended to limit the present invention. Any ornamental design that complies with the structural integrity of the pulley covers and grill are contemplate within the scope of this patent application.

The present invention is illustrated by the previous examples. However, it should be understood that the invention is not limited to the specific details of these examples. It will now be apparent to those skilled in the art that other embodiments, improvements, details, and uses can be made that are consistent with the letter and spirit of the foregoing disclosure and within the scope of this patent application, the appended claims and their legal equivalent.

What is claimed is:

1. A motorcycle primary open belt protective cover for attachment to a primary open belt drive including a front pulley wheel, a rear pulley wheel, and a drive belt, said protective cover comprising:
at least one free-spinning pulley cover;
at least one bearing housing;
at least one bearing rotatably connecting said at least one free-spinning pulley cover and
said at least one bearing housing,
said protective cover being removably attachable to a motorcycle primary open belt drive,
wherein said protective cover is adapted to prevent apparel from getting caught in the open belt drive.

2. The motorcycle primary open belt cover according to claim 1, wherein said at least one bearing housing is driven by said front pulley wheel.

3. The motorcycle primary open belt cover according to claim 1, wherein said at least one bearing housing is fixedly attached to said front pulley wheel.

4. The motorcycle primary open belt cover according to claim 1, wherein said at least one bearing housing is driven by said rear pulley wheel.

5. The motorcycle primary open belt cover according to claim 1, wherein said at least one bearing housing is fixedly attached to said rear pulley wheel.

6. The motorcycle primary open belt cover according to claim 1, wherein said at least one free-spinning pulley cover includes a front cover and a rear cover; and
at least one bearing housing includes a front bearing housing and a rear bearing housing.

7. The motorcycle primary open belt cover according to claim 6, wherein the front bearing housing is driven by a front pulley wheel.

8. The motorcycle primary open belt cover according to claim 6, wherein the rear bearing housing is driven by a rear pulley wheel.

9. The motorcycle primary open belt cover according to claim 6, further including a grill mounted between said front cover and said rear cover.

10. A pulley cover assembly for a motorcycle drive system pulley, said pulley cover assembly comprising:
a pulley mounting plate, said pulley mounting plate being attachable to a motorcycle drive system pulley wheel;
a rotating device; and
a friction reducing device fitted to said pulley mounting plate and said rotating device,
whereby said friction reducing device provides for independent relative rotational motion of said pulley mounting plate with respect to said rotating device.

11. The pulley cover assembly according to claim 10 wherein said rotating device comprises an outer diameter greater than an outer diameter of said pulley mounting plate and the motorcycle drive system pulley wheel.

12. The pulley cover assembly according to claim 11 wherein said rotating device further comprises a rim extending a predetermined length substantially orthogonal to a rear face of said rotating device.

13. The pulley cover assembly according to claim 12 wherein said rim forms a cavity of sufficient size to substantially or entirely enclose said mounting plate.

14. The pulley cover assembly according to claim 10 wherein said rotating device comprises an ornamental design.

15. A motorcycle drive system cover assembly used in conjunction with a motorcycle, the motorcycle including a drive system having a front pulley wheel, a rear pulley wheel, and a drive means operably connecting the front pulley wheel and the rear pulley wheel, said cover assembly comprising:
a front rotating pulley cover mountable to the front pulley wheel;
a rear rotating pulley cover mountable to the rear pulley wheel; and
a grill oriented between said front rotating pulley cover and said rear rotating pulley cover, said grill attachable to a frame of the motorcycle.

16. The motorcycle drive system cover assembly according to claim 15 wherein each of said rotating pulley covers comprise:
a pulley mounting plate, said pulley mounting plate being attachable to the motorcycle drive system pulley;
a rotating device; and
a friction reducing device fitted to said pulley mounting plate and said rotating device,
whereby said friction reducing device provides for independent relative rotational motion of said pulley mounting plate with respect to said rotating device.

17. The motorcycle drive system cover assembly according to claim 15 wherein said grill comprises:
a front plate; and
a mounting frame having a outer side and an inner side, said outer side being attachable to said front plate and said inner side being attachable on the frame of the motorcycle.

18. The motorcycle drive system cover assembly according to claim 17 wherein said front plate comprises:
said front plate having a substantially trapezoidal shape;
a pair of sides, an upper edge, and a lower edge;
each side of said pair of sides having a cutout;
said cutout having a semi-circular configuration, said semi-circular configuration having a radius slightly larger than a radius of said rotating device adjacent thereto;
said upper and lower edges being tapered outward from said front rotating pulley cover to said rear rotating pulley cover to create a smooth edge transient between said front plate and said rotating pulley covers,
whereby, gaps between said front rotating pulley cover, said rear rotating pulley covers, and said front plate are minimized providing when assembled for the reduced probability of obstacles, debris and/or other foreign matter from entering the motorcycle drive system.

19. The motorcycle drive system cover assembly according to claim 17 wherein:
said front plate includes a plurality of mounting holes; and
said outer side of said mounting frame includes a plurality of holes of having diameters complimentary to said plurality of mounting holes of said front plate,
whereby, said front plate and said mounting frame are clamped together with conventional bolts and nuts or screws.

20. The motorcycle drive system cover assembly according to claim 17 wherein said front plate comprise an ornamental design.
